(19) United States
(12) Patent Application Publication
(10) Pub. No.: US 2012/0251739 A1
(43) Pub. Date: Oct. 4, 2012

(54) OPTICAL FILM, POLARIZER, AND IMAGE DISPLAY DEVICE

(75) Inventors: Yumi KATO, Kanagawa (JP); Kazuo KAMOHARA, Kanagawa (JP); Mamoru SAKURAZAWA, Kanagawa (JP)

(73) Assignee: FUJIFILM CORPORATION, Tokyo (JP)

(21) Appl. No.: 13/427,473

(22) Filed: Mar. 22, 2012

(30) Foreign Application Priority Data
Mar. 31, 2011 (JP) 2011-080595
Sep. 20, 2011 (JP) 2011-204677

(51) Int. Cl. B32B 23/20; C09K 19/20

(52) U.S. Cl. 428/1.33; 428/336

(57) ABSTRACT

An optical film comprising a cellulose ester film and, as formed on at least one surface thereof, a hard coat layer having a thickness of from 0.1 to 6 μm, wherein the tensile elastic modulus of the cellulose ester film both in the machine direction (MD) thereof and in the direction transverse to the machine direction (TD) thereof is at least 4.0 GPa.

### CROSS-REFERENCE TO RELATED APPLICATIONS

The present application claims the benefit of priority from Japanese Patent Application No. 2011-080595 filed on Mar. 31, 2011 and Japanese Patent Application No. 2011-204677 filed on Sep. 20, 2011, the contents of which are herein incorporated by reference in their entirety.

### BACKGROUND OF THE INVENTION

1. Field of the Invention

The present invention relates to an optical film useful as a surface protective film for image display devices, etc., and to a polarizer and an image display device comprising the film.

2. Description of the Related Art

A protective film is provided on the surface of an image display device such as typically liquid-crystal displays (LCD), plasma display panels (PDP), electroluminescence displays (ELD), etc. The protective film to be used is generally provided with a hard coat layer for imparting thereto mechanical strength such as abrasion resistance, etc. The hard coat layer is preferably thinner from the viewpoint of physical improvement for brittleness reduction, curling prevention or the like and from the viewpoint of weight saving and production cost cutting, and it is said that the thickness thereof must be at most 6 μm; however, on the other hand, from the viewpoint of the abrasion resistance thereof, too much thinning the layer is undesirable. When the hard coat layer is thinned, then the pencil hardness, which is an index of the abrasion resistance of the layer, may lower. Specifically in existing technology, it has heretofore been difficult to attain both thinning the hard coat layer and increasing the pencil hardness of the hard coat layer.

For increasing the hardness of the hard coat layer, the material of the hard coat layer itself has heretofore been specifically noted inmost techniques, but there are known few techniques relating to the substrate film for the hard coat layer.

Patent Reference 1 discloses a polarizer protective film, in which the polarizer is provided with a first protective film having a hard coat layer and a second protective film composed of a polymerizing liquid-crystal compound layer of which the hardness falls within a predetermined range and a transparent film of which the degree of elasticity in the cross direction falls within a predetermined range.

Patent Reference 2 discloses an optical filter of which the degree of surface elasticity of the surface coated with a hard coat layer falls within a predetermined range.

However, the techniques disclosed in these patent publications are not for thinning the hard coat layer.

On the other hand, a cellulose ester film of typically cellulose acetate is highly transparent, and has heretofore been much used in various applications for image display devices. For example, the film is used as a polarizer protective film in liquid-crystal display devices as readily securing good adhesiveness to polyvinyl alcohol used in polarizer.

For example, Patent Reference 3 discloses a polarizer in which the polarizing element is sandwiched between two cellulose ester films of which the ratio of TD elasticity/MD elasticity falls within a predetermined range. The patent reference further discloses formation of a hard coat layer on the cellulose acylate film, of which the ratio of TD elasticity/MD elasticity is from 1.4 to 2.2, of the two cellulose acylate films.

Patent Reference 4 also discloses an optical film containing a cellulose ester or the like, of which the ratio of TD elasticity/MD elasticity falls within a predetermined range, and a polarizer having a protective film of the optical film.

### CITATION LIST

Patent Reference 1: JP-A 2010-107639
Patent Reference 2: JP-A 2002-55225
Patent Reference 3: JP-A 2009-265365
Patent Reference 4: JP-A 2009-210777

The present inventors investigated the above and have known that, when a thin hard coat layer having a thickness of not more than 6 μm is formed on the cellulose ester film disclosed in the above-mentioned Patent References 3 and 4, then the hardness of the film may often significantly lower in some direction in testing the film for the pencil hardness thereof.

The present invention has been made in consideration of the above-mentioned problems, and its object is to provide an optical film having a hard coat layer having a thickness of not more than 6 μm and excellent in abrasion resistance, and to provide a polarizer and an image display device comprising the film.

### SUMMARY OF THE INVENTION

The present inventors have assiduously studied for the purpose of solving the above-mentioned problems and, as a result, have known that the problems can be solved by increasing both the MD and TD tensile elasticity of the film; and on the basis of this finding, the inventors have made further investigations and have completed the present invention.

The means for solving the above-mentioned problems are as follows:

[1] An optical film comprising a cellulose ester film and, as formed on at least one surface thereof, a hard coat layer having a thickness of from 0.1 to 6 μm, wherein the tensile elastic modulus of the cellulose ester film both in the machine direction (MD) thereof and in the direction transverse to the machine direction (TD) thereof is at least 4.0 GPa.
[2] The optical film of [1], wherein the ratio of the TD tensile elastic modulus to the MD tensile elastic modulus of the cellulose ester film is less than 1.4.
[3] The optical film of [1] or [2], wherein the cellulose ester film comprises at least one sugar ester.
[4] The optical film of [3], wherein the sugar ester is a mixture of multiple sugar ester compounds that are the same in point of the type of the ester substituent therein but differ in point of the degree of ester substitution therein, and wherein the mean ester substitution ratio of those multiple sugar ester compounds differing in point of the degree of ester substitution therein is from 62 to 94%.
[5] The optical film of any one of [1] to [4], wherein the cellulose ester film is a stretched film.
[6] The optical film of any one of [1] to [5], wherein the hard coat layer is a polyfunctional (meth)acrylate-base hard coat layer.
[7] An image display device having the optical film of any one of [1] to [6] on the display surface of the panel thereof.
[8] A polarizer having a polarizing element and the optical film of any one of [1] to [6].
[9] A liquid-crystal display device at least having the polarizer of [8].

According to the invention, there is provided an optical film having a hard coat layer having a thickness of not more than 6 μm and excellent in abrasion resistance.

### BEST MODE FOR CARRYING OUT THE INVENTION

The contents of the invention are described in detail hereinunder. The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

In this description, “MD” means the machine direction of cellulose ester film, and “TD” means the direction transverse thereto. Of long cellulose ester film, “MD” corresponds to the longitudinal direction, and “TD” corresponds to the cross direction. “MD” and “TD” would be difficult to identify in some cases; and in such cases, one of the long side and the short side of a rectangular film sample could be arbitrarily defined as MD and the other as TD, and the tensile elastic modulus of the film could be computed.

### 1. Optical Film:

The invention relates to an optical film comprising a cellulose ester film and, as formed on at least one surface thereof, a hard coat layer having a thickness of from 0.1 to 6 μm, wherein the tensile elastic modulus of the cellulose ester film both in the machine direction (MD) thereof and in the direction transverse to the machine direction (TD) thereof is at least 4.0 GPa. The optical film of the invention is characterized in that the tensile elastic modulus of the cellulose ester film that is the substrate of the hard coat layer is at least 4.0 GPa in any direction of MD and TD. Having made assiduous studies, the present inventors have known that, when the hard coat layer is thin and when there exists anisotropy in the tensile elastic modulus of the substrate film, then they would have some influences on the hardness of the hard coat layer and, for example, even though the hard coat layer could have high hardness in a predetermined direction but the hardness thereof noticeably lowers in the other direction. In the invention, a cellulose ester film having a high tensile elastic modulus in both directions of MD and TD is used, therefore attaining a high pencil hardness (or that is, excellent abrasion resistance) of the optical film even though the hard coat layer is a thin layer having a thickness of at most 6 μm. Moreover, the thin hard coat layer enables weight saving and production cost cutting with no problem of curling that detracts from the handlability of the film, and is free from a problem of brittleness. Further preferably, the adhesiveness between the hard coat layer and the substrate film thereof, or that is, the underlying cellulose ester film is excellent.

Of the cellulose ester film for use in the invention, the tensile elastic modulus in MD and TD is at least 4.0 GPa. The tensile elastic modulus is preferably higher, but is preferably so high as not to make the film brittle. From the viewpoint, the tensile elastic modulus in MD and TD is preferably from 4.0 to 5.5 GPa. Also preferably, the difference in the tensile elastic modulus between MD and TD is not large, and is ideally substantially the same therebetween. Concretely, the ratio of the tensile elastic modulus in TD of the cellulose ester film to the tensile elastic modulus in MD thereof (TD tensile elastic modulus/MD tensile elastic modulus) is preferably less than 1.4, more preferably less than 1.3, even more preferably from 0.9 to 1.2.

The tensile elastic modulus of the cellulose ester film can be determined by measuring the stress in 0.5% elongation in an atmosphere at 23° C. and at a relative humidity of 60% at a pulling rate of 10%/min, using Toyo Boldwin's universal tensile tester “STM T50BP”.

The cellulose ester film and the hard coat layer constituting the optical film of the invention are described in detail hereinunder.

### [Cellulose Ester Film]

### (Cellulose Ester)

Preferably, the cellulose ester film that the optical film of the invention has contains cellulose acylate as the main ingredient thereof. The cellulose acylate for use in the invention is not specifically defined. Above all, preferred is use of a cellulose acylate having a degree of acetyl substitution of from 2.70 to 2.95. When the degree of acetyl substitution thereof is at least 2.7, the cellulose acylate has good miscibility with sugar esters satisfying the requirements mentioned below (for example, sucrose benzoate having a specific degree of substitution, etc.), and is favorable as the film formed is hardly whitened. Further, the cellulose acylate of the type is also preferred since, in addition to the transparency thereof, the moisture permeability and the water content of the film to be formed are good. Still other advantages are that the polarizer durability and the wet heat durability of the film itself are also good. On the other hand, the degree of substitution is preferably at most 2.95 from the viewpoint of the optical performance of the film to be formed.

Preferably, the degree of acetyl substitution of the cellulose acylate is from 2.75 to 2.90, more preferably from 2.82 to 2.87.

The preferred range of the total degree of acyl substitution is also the same as the preferred range of the degree of acetyl substitution mentioned above.

The degree of acyl substitution can be determined according to the method defined in ASTM-D817-96. The part not substituted with an acyl group generally exists as a hydroxyl group.

The acyl group having from 2 to 22 carbon atoms that substitutes for the hydroxyl group in cellulose may be an aliphatic group or an aryl group with no specific limitation thereon, and may be a single group or a mixture of multiple groups as combined. The group includes, for example, alkylcarbonyl esters of cellulose, alkenylcarbonyl esters or aromatic carbonyl esters of cellulose, which may further have a substituted group. Preferred examples of the acyl group include acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl, cinnamoyl groups, etc. Of those, preferred are acetyl, propionyl, butanoyl, dodecanoyl, octadecanoyl, t-butanoyl, oleoyl, benzoyl, naphthylcarbonyl, cinnamoyl groups, etc.; and more preferred are acetyl, propionyl and butanoyl groups.

The substituent in the cellulose acylate for use in the invention is preferably an acetyl group.

A mixed fatty acid cellulose acylate may also be used here. Concretely, the mixed fatty acid cellulose acylate includes cellulose acetate propionate, and cellulose acetate butyrate.

A basic principle of the production method for cellulose acylate is described in Migita et al's Wood Chemistry, pp. 180-190 (by Kyoritsu Publishing, 1968). One typical production method is a liquid-phase acetylation method using a carboxylic acid anhydride-acetic acid-sulfuric acid catalyst.

For obtaining the cellulose acylate, concretely, a starting cellulose material such as cotton linter, wood pulp or the like is pretreated with a suitable amount of acetic acid, put into a previously-cooled mixture solution for carboxylation in which the material is esterified thereby producing a complete cellulose acylate (the total degree of acyl substitution at the 2-, 3- and 6-positions is nearly 3.00). The mixture solution for carboxylation generally contains acetic acid as a solvent, a carboxylic acid anhydride as an esterifying agent and sulfuric acid as a catalyst. In general, the carboxylic acid anhydride is used in a stoichiometrically excessive amount over the total of the cellulose to be reacted with it and the water content existing in the system. After the esterification, an aqueous solution of a neutralizing agent (for example, calcium, magnesium, iron, aluminium or zinc carbonate, acetate or oxide) is added to the system for hydrolyzing the excessive carboxylic acid anhydride remaining in the system and for neutralizing a part of the esterification catalyst. Next, the obtained complete cellulose acylate is saponified and aged in the presence of a small amount of an acetylation catalyst (generally, this is sulfuric acid remaining in the system) at 50 to 90° C., thereby converting it into a cellulose acylate having a desired degree of acyl substitution and a desired degree of polymerization. At the time when the desired cellulose acylate is obtained, the catalyst remaining in the system is completely neutralized with the above-mentioned neutralizing agent, or without such neutralization, the cellulose acylate solution is put into water or diluted sulfuric acid (or water or diluted sulfuric acid is put into the cellulose acylate solution) to thereby separate, wash and stabilize the cellulose acylate to give the above-mentioned specific cellulose acylate.

Preferably, the number-average molecular weight (Mn) of the cellulose acylate is from 40000 to 200000, more preferably from 100000 to 200000. Also preferably, Mw/Mn of the cellulose acylate for use in the invention is at most 4.0, more preferably from 1.4 to 2.3.

In the invention, the mean molecular weight and the molecular weight distribution of cellulose acylate and others can be determined by measuring the number-average molecular weight (Mn) and the weight-average molecular weight (Mw) thereof through gel permeation chromatography (GPC) followed by computing the ratio thereof according to the method described in WO2008-126535.

The cellulose ester film may contain at least one plasticizer along with the main ingredient, cellulose acylate therein. However, plasticizer generally lower the modulus of elasticity of film, and therefore, it is important to suitably select the type of the plasticizer to be used and to control the amount to be added thereof. Adding a sugar ester and a polycondensate oligomer-type plasticizer in a small amount is favorable as contributing toward increasing the tensile elastic modulus of the film formed. Above all, preferred are an aromatic group-having sugar ester and a polycondensate oligomer-type plasticizer; and more preferred is a sugar ester. For example, when a cellulose ester film containing a sugar ester is stretched (preferably stretched biaxially), the MD and TD tensile elastic modulus of the film can be increased up to the above-mentioned range. In addition, sugar ester contributes toward enhancing the adhesiveness of the cellulose ester film to the hard coat layer formed thereon.

### (Sugar Ester)

The sugar ester usable in the invention may be a monose ester or a polyose ester. Preferred are esters of monoses or dioses to tetroses; more preferred are esters of monoses or dioses to trioses; and even more preferred are esters of dioses. Sugar (including all of monoses and polyoses) has multiple OH groups in one molecule, and it is unnecessary that all of those OH groups are substituted with ester groups. In particular, it is desirable that unsubstituted OH groups remain in a sugar ester substituted with an ester group that has an aromatic ring-containing group, from the viewpoint of the miscibility thereof with cellulose acylate and of the effect thereof of increasing the elastic modulus of the film to be formed.

Preferably, a mixture of multiple sugar ester compounds is used here as combined. More preferred is a mixture of multiple sugar ester compounds that differ in point of the degree of ester substitution thereof. The mean ester substitution ratio of those multiple sugar ester compounds that differ in point of the degree of ester substitution thereof is not specifically defined, and the mixture may contain unsubstituted compounds.

The “mean ester substitution ratio” of the mixture of sugar ester compounds that are the same in point of the type of the substituent thereof but differ in point of the degree of ester substitution therein can be computed according to the following formula:

Mean Ester Substitution ratio=100%×(content of sugar esters in the mixture)×(number of esterified OH groups in one molecule of sugar esters in the mixture)/(total number of OH groups in one molecule of unsubstituted sugar).

In the above formula, the “content of sugar esters in the mixture” can be computed from the ratio of peak areas in HPLC.

In this description, monoses and polyoses include sugar derivatives that contain a sugar residue in the structure thereof such as gluconic acid derived from those sugar compounds, and esters of those sugar compounds are also usable here. In an ester of a carboxyl group-having sugar derivative such as gluconic acid, not only the OH groups in one molecule of the sugar residue to be the mother nucleus but also COOH groups therein are also esterified; and therefore in computing the mean ester substitution ratio of the esters of such sugar derivatives, the ester substitution for the COOH groups shall be taken into consideration for the mean ester substitution ratio of those esters.

The sugar ester includes a structure derived from a monose or a polyose that constitutes the sugar ester (hereinafter this may be referred to as a sugar residue). The structure per the monose of the sugar residue is referred to as a structural unit of the sugar ester. The structural unit of the sugar ester preferably contains a pyranose structural unit or a furanose structural unit, more preferably, all the sugar residues in the sugar ester are pyranose structural units or furanose structural units. In case where the sugar ester is composed of a polyose, the ester preferably contains a pyranose structural unit or a furanose structural unit.

The sugar residue of the sugar ester may be a pentose-derived or hexose-derived one.

In the invention, preferably, the sugar ester is a sugar ester in which at least one hydroxyl group is esterified to form from 1 to 3 pyranose structural units or furanose structural units therein, and more preferred is a sugar ester in which at least one hydroxyl group is esterified to form 2 pyranose structural units or furanose structural units therein.

Examples of the above-mentioned monoses or dioses to tetroses include erythrose, threose, ribose, arabinose, xylose, lyxose, arose, altrose, glucose, fructose, mannose, gulose, idose, galactose, talose, trehalose, isotrehalose, neotrehalose, trehalosamine, kojibiose, nigerose, maltose, maltitol, isomaltose, sophorose, laminaribiose, cellobiose, gentiobiose, lactose, lactosamine, lactitol, lactulose, melibiose, primeverose, rutinose, scillabiose, sucrose, sucralose, turanose, vicianose, cellotriose, chacotriose, gentianose, isomaltotriose, isopanose, maltotriose, manninotriose, melezitose, panose, planteose, raffinose, solatriose, umbelliferose, lycotetraose, maltotetraose, stachyose, baltopentaose, verbascose, maltohexaose, xylitol, sorbitol, etc.

Preferred are ribose, arabinose, xylose, lyxose, glucose, fructose, mannose, galactose, trehalose, maltose, cellobiose, lactose, sucrose, sucralose, xylitol, sorbitol; more preferred are arabinose, xylose, glucose, fructose, mannose, galactose, maltose, cellobiose, sucrose; and even more preferred are xylose, glucose, fructose, mannose, galactose, maltose, cellobiose, sucrose, xylitol, sorbitol.

The ester residue —OC(═O)R of the sugar ester is not specifically defined. R may be an aliphatic group or an aromatic group. The aliphatic group may have a substituent. The aromatic group may be a heterocyclic group or a hydrocarbon group. Further, two or more different ester substituents may exist in one molecule of the sugar ester. Further, two or more different types of sugar esters each having a different ester substituent may be used here as combined.

Preferred examples of the acyl group —C(═O)R that constitutes the ester residue —OC(═O)R of the sugar ester include an aliphatic or aromatic acyl group having from 1 to 22 carbon atoms, more preferably from 2 to 12 carbon atoms, even more preferably from 2 to 8 carbon atoms. Concretely, the acyl group includes an acetyl group, a propionyl group, a butyryl group, a pentanoyl group, a hexanoyl group, an octanoyl group, a benzoyl group, a toluoyl group, a phthalyl group. Above all, preferred is use of at least one sugar ester having at least a benzoyl group.

The sugar ester usable in the invention may have, along with the ester residue therein, a substituent for the OH group in which H is substituted with any other substituent than acyl group —C(═O)R. When the substituent is represented by —OX, examples of X include an alkyl group (preferably an alkyl group having from 1 to 22 carbon atoms, more preferably from 1 to 12 carbon atoms, even more preferably from 1 to 8 carbon atoms, for example, a methyl group, an ethyl group, a propyl group, a hydroxyethyl group, a hydroxypropyl group, a 2-cyanoethyl group, a benzyl group, etc.), an aryl group (preferably an aryl group having from 6 to 24 carbon atoms, more preferably from 6 to 18 carbon atoms, even more preferably from 6 to 12 carbon atoms, for example, a phenyl group, a naphthyl group, etc.), an amide group (preferably an amide group having from 1 to 22 carbon atoms, more preferably from 2 to 12 carbon atoms, even more preferably from 2 to 8 carbon atoms, for example, a formamide group, an acetamide group, etc.), an imide group (preferably an imide group having from 4 to 22 carbon atoms, more preferably from 4 to 12 carbon atoms, even more preferably from 4 to 8 carbon atoms, for example, a succinimide group, a phthalimide group, etc.).

Preferably, the sugar ester for use in the invention has, as the substituent therein, an ester residue —OC(═O)R alone and partly has some unsubstituted OH groups remaining therein.

Preferred examples of the sugar ester for use in the invention are those having a structure represented by the following general formula (1):

(OH)ₚ-G-(L¹-R¹¹)_{q}(O—R¹²)ᵣ (1)

wherein G represents a sugar residue; L¹ represents any one of —O—, —CO— or —NR¹³—; R¹¹ represents a hydrogen atom or a monovalent substituent; R¹² represents a monovalent substituent bonding to the formula via an ester bond; p, q and r each independently indicate an integer of 0 or more, and p+q+r is equal to the number of the hydroxyl groups on the presumption that G is an unsubstituted sugar group having a cyclic acetal structure.

The preferred range of G is the same as the preferred range of the above-mentioned sugar residue.

L¹ is preferably —O— or —CO—, more preferably —O—. When L¹ is —O—, it is more preferably an ether bond or an ester bond-derived linking group, even more preferably an ester bond-derived linking group.

In case where the formula has multiple L¹'s, then they may be the same or different.

Preferably, at least one of R¹¹ and R¹² has an aromatic ring.

In particular, in case where L¹ is —O— (or that is, in case where the hydroxyl group in the above-mentioned sugar ester compound is substituted with R¹¹ and R¹²), preferably, RH, R¹² and R¹³ are selected from a substituted or unsubstituted acyl group, a substituted or unsubstituted aryl group, a substituted or unsubstituted alkyl group, or a substituted or unsubstituted amino group, more preferably from a substituted or unsubstituted acyl group, a substituted or unsubstituted alkyl group, or a substituted or unsubstituted aryl group, even more preferably from an unsubstituted acyl group, a substituted or unsubstituted alkyl group, or an unsubstituted aryl group.

In case where the formula has multiple R¹¹'s, R¹²'s and R¹³'s, they may be the same or different.

p is an integer of 0 or more, and its preferred range is the same as the preferred range of the number of the hydroxyl groups per the monose unit to be mentioned below.

r is preferably a number larger than the number of the pyranose structural units or the furanose structural units contained in G.

q is preferably 0.

p+q+r is equal to the number of the hydroxyl groups on the presumption that G is an unsubstituted sugar group having a cyclic acetal structure, and therefore, the uppermost limit of these p, q and r is specifically defined depending on the structure of G.

The sugar esters are available as commercial products from Tokyo Chemical, Aldrich, etc., or may be produced according to known methods of converting commercially-available hydrocarbons into ester derivatives thereof (for example, according to the method described in JP-A 8-245678).

Preferably, the sugar ester has a number-average molecular weight of from 200 to 3500, more preferably from 200 to 3000, even more preferably from 250 to 2000.

Specific examples of the sugar esters preferred for use in the invention are mentioned below; however, the invention is not limited to the following embodiments.

In the structural formulae mentioned below, R each independently represents an arbitrary substituent, and multiple R's may be the same or different. The ClogP value is a value of the common logarithm of the partition coefficient P between 1-octanol and water, as obtained through computation. For computation to give the ClogP value, used was the CLOGP program installed in the system, PC Models by Daylight Chemical Information Systems.

TABLE 1

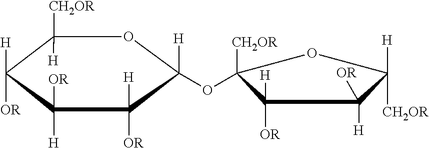

| | Substituent 1 | | Substituent 2 | | |
|---|---|---|---|---|---|
| Com- | | degree of | | degree of | Molecular |
| pound | type | substitution | type | substitution | Weight |
| 101 | acetyl | 7 | benzyl | 1 | 727 |
| 102 | acetyl | 6 | benzyl | 2 | 775 |
| 103 | acetyl | 7 | benzoyl | 1 | 741 |
| 104 | acetyl | 6 | benzoyl | 2 | 802 |
| 105 | benzyl | 2 | no | 0 | 523 |
| 106 | benzyl | 3 | no | 0 | 613 |
| 107 | benzyl | 4 | no | 0 | 702 |
| 108 | acetyl | 7 | phenyl- | 1 | 771 |
| | | | acetyl | | |
| 109 | acetyl | 6 | phenyl- | 2 | 847 |
| | | | acetyl | | |
| 110 | benzoyl | 1 | no | — | 446 |
| 111 | benzoyl | 2 | no | — | 550 |
| 112 | benzoyl | 3 | no | — | 654 |
| 113 | benzoyl | 4 | no | — | 758 |
| 114 | benzoyl | 5 | no | — | 862 |
| 115 | benzoyl | 6 | no | — | 966 |
| 116 | benzoyl | 7 | no | — | 1070 |
| 117 | benzoyl | 8 | no | — | 1174 |

TABLE 2

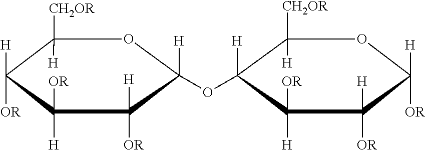

| | Substituent 1 | | Substituent 2 | | |
|---|---|---|---|---|---|
| | | degree of | | degree of | Molecular |
| Compound | type | substitution | type | substitution | Weight |
| 301 | acetyl | 6 | benzoyl | 2 | 803 |
| 302 | acetyl | 6 | benzyl | 2 | 775 |
| 303 | acetyl | 6 | phenyl- | 2 | 831 |
| | | | acetyl | | |
| 304 | benzoyl | 2 | no | 0 | 551 |
| 305 | benzyl | 2 | no | 0 | 522 |
| 306 | phenyl- | 2 | no | 0 | 579 |
| | acetyl | | | | |

TABLE 3

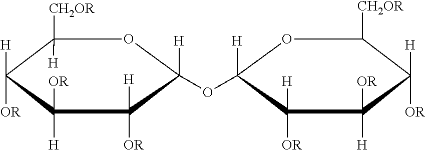

| | Substituent 1 | | Substituent 2 | | |
|---|---|---|---|---|---|
| Com- | | degree of | | degree of | Molecular |
| pound | type | substitution | type | substitution | Weight |
| 401 | acetyl | 6 | benzoyl | 2 | 803 |
| 402 | acetyl | 6 | benzyl | 2 | 775 |
| 403 | acetyl | 6 | phenyl- | 2 | 831 |
| | | | acetyl | | |
| 404 | benzoyl | 2 | no | 0 | 551 |
| 405 | benzyl | 2 | no | 0 | 523 |
| 406 | phenyl- | 2 | no | 0 | 579 |
| | acetyl | | | | |

Preferably, the film of the invention contains the sugar ester in an amount of from 2% by mass to less than 25% by mass relative to the main ingredient, cellulose acylate therein, more preferably from 5 to 20% by mass, even more preferably from to 15% by mass.

Preferably, the film of the invention contains multiple sugar ester compounds that are the same in point of the type of the ester substituent therein but differ in point of the degree of ester substitution therein, and the mean ester substitution ratio of those multiple sugar ester compounds differing in point of the degree of ester substitution therein is from 62% to 94%. As the sugar ester compounds that are the same in point of the type of the ester substituent therein but differ in point of the degree of ester substitution therein, preferred is use of sugar esters substituted with an ester group having an aromatic ring-containing group; more preferred is use of sugar esters substituted with a benzoyl group-having ester residue; and even more preferred is use of such sugar esters having a mean ester substitution ratio of from 62% to 94%.

In case where the sugar ester compound is a biose, the mean value of the number of the esterified substituents is preferably from 5 to 7.5, and more preferably, the content of high-substituted esters having from 6 to 8 esterified substituents is at most 80% and the content of substituted esters having from 3 to 4 esterified substituents is from 5 to 30%.

In another preferred embodiment of the invention, used is a mixture of a sugar ester substituted with an ester group having an aromatic ring-containing group (preferably a benzoyl group—the same shall apply hereinunder) and a sugar ester substituted with an ester group having an aliphatic acyl group (acetyl group, a butyryl group, a propionyl group, etc.). In this, preferably, the mean ester substitution ratio of the sugar esters substituted with an ester group having an aromatic ring-containing group is from 62% to 94%. The sugar ester substituted with an ester group having an aliphatic acyl group maybe a sugar ester having a single degree of ester substitution or may also be a mixture of sugar ester compounds each having the same aliphatic acyl group but differing in point of the degree of ester substitution therein. The blend ratio of the sugar ester substituted with an ester group having an aromatic ring-containing group and the sugar ester substituted with an ester group having an aliphatic acyl group is preferably from 1/0 to 1/3, more preferably from 1/0 to 1/1.

### (UV Absorbent)

Preferably, the cellulose ester film for use in the invention contain a UV absorbent along with the main ingredient, cellulose acylate therein. The UV absorbent contributes toward improving the durability of the film. In particular, in an embodiment where the optical film is used as the surface protective film in image display devices, adding a UV absorbent to the film is effective.

The UV absorbent usable in the invention is not specifically defined. Any UV absorbent heretofore used in cellulose esters is usable here. As the UV absorbent, herein mentioned are the compounds described in JP-A 2006-184874. Polymer UV absorbents are also preferred for use herein, and in particular, the polymer UV absorbents described in JP-A 6-148430 are preferred.

The amount of the UV absorbent to be added to the film is not uniform but may vary depending on the type of the UV absorbent and on the conditions for use of the film. Preferably, the UV absorbent is added to the film in a ratio of from 1 to 3% by mass of the main ingredient, cellulose acylate in the film.

The following UV-1 to UV-3 are examples of the UV absorbent, to which, however, the invention is not limited.

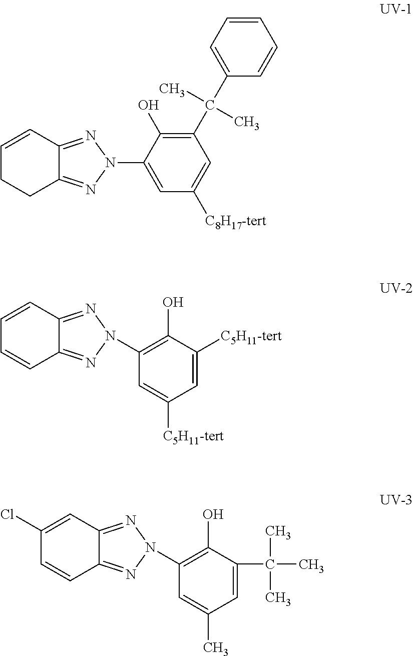

### (Other Additives)

The cellulose ester film in the invention may contain at least one other additive within a range not detracting from the advantages of the invention. Examples of the other additives include plasticizers except sugar esters (for example, phosphate-type plasticizer, carboxylate-type plasticizer, polycondensate oligomer-type plasticizer, etc.). As described above, aromatic group-having polycondensate oligomer-type plasticizers are preferred as capable of increasing the tensile elastic modulus of the film to which the plasticizer is added, like sugar esters. Aromatic group-having polycondensate oligomer-type plasticizers usable herein are described in JP-A 2010-242050 and 2006-64803, and these are usable in the invention.

### (Production Method for Cellulose Ester Film)

The production method for the cellulose ester film for use in the invention is not specifically defined, and the film can be produced according to known methods. For example, the film can be produced according to a solution casting method or a melt casting method. From the viewpoint of bettering the film surface condition, the film is produced preferably according to a solution casting method. The production method employable in the invention is described below with reference to an embodiment of solution casting film formation; however, the invention is not limited to the mode of solution casting film formation. In case where the film of the invention is produced according to a melt casting method, any known method is employable.

### (Polymer Solution)

In the solution casting film formation method, a polymer solution containing cellulose acylate, sugar ester and optionally various additives (cellulose acylate solution) is formed into a web. The polymer solution for use in the solution casting film formation method (hereinafter this maybe referred to as cellulose acylate solution) is described below.

### (Solvent)

The cellulose acylate for use in the invention is dissolved in a solvent to form a dope, which is cast on a substrate to form a film thereon. In this step, the solvent must be evaporated away after extrusion or casting, and therefore, a volatile solvent is preferably used.

Further, the solvent is one not reacting with a reactive metal compound, a catalyst or the like and not dissolving the casting substrate. Two or more different types of solvents may be used here as combined.

As the case may be, a cellulose acylate and a hydrolyzable and polycondensable reactive metal compound may be dissolved in different solvents, and the resulting solutions may be mixed later.

An organic solvent capable of well dissolving the cellulose acylate is referred to as a good solvent, and an organic solvent exhibiting the main effect for the dissolution and used in a major amount is referred to as a main (organic) solvent.

Examples of the good solvent include ketones such as acetone, methyl ethyl ketone, cyclopentanone, cyclohexanone, etc.; ethers such as tetrahydrofuran (THF), 1,4-dioxane, 1,3-dioxolan, 1,2-dimethoxyethane, etc.; esters such as methyl formate, ethyl formate, methyl acetate, ethyl acetate, amyl acetate, γ-butyrolactone, etc.; as well as methyl cellosolve, dimethylimidazolinone, dimethylformamide, dimethylacetamide, acetonitrile, dimethyl sulfoxide, sulforane, nitroethane, methylene chloride, methyl acetacetate, etc. Preferred are 1,3-dioxolan, THF, methyl ethyl ketone, acetone, methyl acetate and methylene chloride.

Preferably, the dope contains from 1 to 40% by mass of an alcohol having from 1 to 4 carbon atoms, in addition to the above-mentioned organic solvent.

The alcohol serves as a gelling solvent in such a manner that, after the dope has been cast on a metal support, the solvent begins to evaporate and the proportion of the alcohol in the dope increases whereby the web (the dope film formed by casting the cellulose acylate dope on a support may be referred to as web) may be readily gelled and may be well peeled from the metal support. In case where the proportion of the alcohol is small, it may play a role in promoting the dissolution of cellulose acylate in a chlorine-free organic solvent, or may play a role in retarding the gellation and precipitation of reactive metal compound and retarding the viscosity increase of the dope.

The alcohol having from 1 to 4 carbon atoms includes methanol, ethanol, n-propanol, iso-propanol, n-butanol, sec-butanol, tert-butanol, propylene glycol monomethyl ether, etc.

Of those, preferred is ethanol as having the advantages of excellent stability in dope, relatively low boiling point, good dryability and nontoxicity. These organic solvents do not have the ability to dissolve cellulose acylate by themselves and are therefore poor solvents.

The cellulose acylate to constitute the cellulose acylate film of the invention contains a hydroxyl group or a hydrogen-bonding functional group of esters, ketones or the like, and therefore it is desirable that the solvent contains an alcohol in an amount of from 5 to 30% by mass of the whole solvent, more preferably from 7 to 25% by mass, even more preferably from 10 to 20% by mass, from the viewpoint of reducing the film peeling load from the casting support.

In the invention, it is also effective to make the film contain a small amount of water for controlling the dope viscosity, for increasing the wet film strength in drying and for increasing the dope intensity in drum casting. For example, water may be in the dope in an amount of from 0.1 to 5% by mass of the whole dope, preferably from 0.1 to 3% by mass, more preferably from 0.2 to 2% by mass.

Examples of the combination of organic solvents preferred for use as the solvent for the polymer solution in the invention are described in JP-A 2009-262551.

If desired, a non-halogen organic solvent may be used as the main solvent, and its details are described in Hatsumei Kyokai Disclosure Bulletin (No. 2001-1745, published by the Hatsumei Kyokai on Mar. 15, 2001).

The cellulose acylate concentration in the polymer solution in the invention is preferably from 5 to 40% by mass, more preferably from 10 to 30% by mass, most preferably from 15 to 30% by mass.

The cellulose acylate concentration can be so controlled that it could reach a predetermined level in the stage of dissolving cellulose acylate in a solvent. If desired, a solution having a low concentration (for example, having a concentration of from 4 to 14% by mass) is previously prepared, and it may be concentrated by evaporating the solvent. Also if desired, a high-concentration solution may be previously prepared and it may be diluted. Adding an additive may lower the cellulose acylate concentration.

The time for additive addition may be suitably determined depending on the type of the additive. For example, sugar ester and UV absorbent may be dissolved in an alcohol such as methanol, ethanol, butanol, etc., or an organic solvent such as methylene chloride, methyl acetate, acetone, dioxolan, etc., or in a mixed solvent of those, and may be added to the dope, or they may be added directly to the dope composition. Those not dissolving in an organic solvent such as an inorganic powder may be dispersed in an organic solvent and a cellulose ester by the use of a dissolver or a sand mill, and then added to the dope.

The solvent that is most preferred for dissolving the polymer compound, cellulose acylate in a high concentration with satisfying the above condition is a mixed solvent of methylene chloride/ethyl alcohol of from 95/5 to 80/20. Also preferred is a mixed solvent of methyl acetate/ethyl alcohol of from 60/40 to 95/5.

### (1) Dissolution Step:

This is a step of dissolving cellulose acylate and additive in an organic solvent comprising mainly a good solvent for the cellulose acylate in a dissolver with stirring therein, to thereby form a dope, or a step of mixing an additive solution in a cellulose acylate solution to form a dope.

For dissolution of cellulose acylate, employable are various dissolution methods such as a method to be attained under normal pressure, a method to be attained at a temperature not higher than the boiling point of the main solvent, a method to be attained under pressure at a temperature not lower than the boiling point of the main solvent, a method of cooling dissolution as in JP-A 9-95544, 9-95557 or 9-95538, a method to be attained under high pressure as in JP-A 11-21379, etc. Especially preferred is the method to be attained under pressure at a temperature not lower than the boiling point of the main solvent.

Preferably, the cellulose acylate concentration in the dope is from 10 to 35% by mass. Additive is added to the dope during or after dissolution and is again dissolved and dispersed therein, then the resulting dope is filtered through a filtering material and defoamed, and thereafter fed to the next step via a feeding pump.

### (2) Casting Step:

This is a step of feeding the dope to a pressure die via a feeding pump (for example, pressure metering gear pump), and casting the dope to the casting position of an endlessly running endless metal belt, for example, a stainless belt, or of a rotating metal support such as a metal drum or the like, through a pressure die slit.

Preferred is a pressure die of which the slit form of the nozzle can be regulated to facilitate uniform film thickness. The pressure die includes a coathanger die, a T-die and the like, any of which is favorably usable here. The surface of the metal support is mirror-finished. For increasing the film formation speed, two or more pressure dies may be provided for a metal support and the dope may be divided for multilayer formation. Multiple dopes may be simultaneously cast according to a co-casting method to produce a laminate-structured film, and the mode is also preferred here.

### (3) Solvent Evaporation Step:

This is a step of heating the web (the precursor that is prior to a finished cellulose acylate film and contains much solvent is referred to as web) on the metal support so as to remove the solvent from the web to such a degree that the web can be released from the metal support.

For solvent evaporation, there may be employed a method of applying an air blow to the side of the web and/or a method of heating the back of the metal support with a heating liquid, a method of heating both the surface and the back of the web by radiation heat, etc. Preferred is the method of heating the back with a heating liquid, as securing good drying efficiency. Also preferred is combination of these methods. In the method of heating the back with a heating liquid, preferably, the back of the support is heated at a temperature not higher than the boiling point of the main solvent of the organic solvent used in the dope or of the organic solvent having the lowest boiling point.

### (4) Peeling Step:

This is a step of peeling the web from which the solvent has been evaporated away on the metal support, at the peeling position. The peeled web is then fed to the next step. When the residual solvent amount (represented by the formula mentioned below) in the web to be peeled is too large, then the web may be difficult to peel, or on the contrary, when the web is too much dried on the metal support and then peeled, then a part of the web may be broken or cut along the way.

In this, as a method of increasing the film formation speed (in which the film formation speed may be increased by peeling the web at a time when the residual solvent amount is as large as possible), there may be mentioned a gel casting method. For example, there are a method of adding a poor solvent for cellulose acylate to the dope, then casting the dope and gelling it; and a method of gelling the dope with lowering the temperature of the metal support. The dope may be gelled on the metal support to thereby increase the strength of the film to be peeled, thereby increasing the film formation speed.

Preferably, the residual solvent amount in the web on the metal support in peeling the web is controlled to fall within a range of from 5 to 150% by mass, depending on the condition of the drying load intensity, the length of the metal support, etc. However, in case where the web is peeled at a time when the residual solvent amount therein is larger, the residual solvent amount in peeling will be determined in consideration of both the economical film formation speed and the film quality. In the invention, the temperature of the peeling position on the metal support is preferably from −50 to 40° C., more preferably from 10 to 40° C., most preferably from 15 to 30° C.

Preferably, the residual solvent amount in the web at the peeling position is from 10 to 150% by mass, more preferably from 10 to 120% by mass.

The residual solvent amount may be expressed by the following formula:

Residual Solvent Amount (% by mass)={(M−N)/N}×100 wherein M is the mass of the web at any point, and N is the mass of the web having the mass of M after dried at 110° C. for 3 hours.

### (5) Drying or Heat Treatment Step, Stretching Step:

After the peeling step, preferably, the web is dried in a drying unit where the web is led to alternately pass through multiple rolls disposed therein and/or in a tenter unit where the web is clipped at both sides thereof and conveyed therethrough.

In heat treatment, if any, in the invention, the heat treatment temperature is lower than (Tg −5° C.), and is preferably from (Tg −20° C.) to lower than (Tg −5° C.), even more preferably from (Tg −15° C.) to lower than (Tg −5° C.)

The heat treatment time is preferably not longer than 30 minutes, more preferably not longer than 20 minutes, even more preferably around 10 minutes.

For drying and heat treatment, in general, a hot air blow is applied to both surfaces of the web; but in place of air, a microwave may be applied thereto for heating. The temperature, the air blow amount and the time may vary depending on the solvent to be used; and suitable conditions may be selected in accordance with the type and the combination of the solvents to be used.

### (Control of Tensile Elastic Modulus)

The cellulose ester film is characterized in that the tensile elastic modulus thereof in MD and TD is at least 4.0 GPa. The MD and TD tensile elastic modulus can be controlled to fall within the above-mentioned range, by applying load to the film in MD, during casting it or during conveying it after casting in the above-mentioned production method, and/or by stretching the film. The film may be uniaxially stretched in either the MD or TD direction or may be biaxially stretched in both the two directions. Biaxial stretching is preferred. The stretching may be attained in one stage or in multiple stages. The tensile modulus elasticity can also be controlled to fall within the above-mentioned range by suitably changing or controlling the type of the cellulose acylate to be used and the degree of acyl substitution thereof, or by suitably selecting the type of the additive such as sugar ester to the film, or by controlling the ratio of the additive.

Preferably, the draw ratio in stretching the film in the machine direction MD is from 0 to 20%, more preferably from 0 to 15%, even more preferably from 0 to 10%. The draw ratio (elongation) in stretching the web may be attained by the peripheral speed difference between the metal support speed and the peeling speed (peel roll draw). For example, in case where an apparatus having two nip rolls is used, the rotation speed of the nip roll on the outlet side is made faster than that of the nip roll on the inlet side, whereby the film may be stretched preferably in the machine direction (longitudinal direction). The stretching may control the MD tensile elastic modulus of the film.

“Draw ratio (%)” as referred to herein is computed according to the following formula:

Draw Ratio (%)=100×{(length after stretching)−(length before stretching)}/(length before stretching).

The draw ratio in stretching the film in the direction TD transverse to the machine direction is preferably from 0 to 60%, more preferably from 10 to 50%, even more preferably from 20 to 50%.

In the method of stretching the film in the direction TD transverse to the machine direction in the invention, preferably used is a tenter apparatus.

In biaxially stretching the film, for example, the film may be relaxed by from 0.8 to 1.0 time in the machine direction to thereby make the film have the desired retardation. The draw ratio in stretching may be defined depending on the intended optical properties of the film. In producing the above-mentioned cellulose acylate film, the film may be monoaxially stretched in the machine direction.

When the stretching temperature is not higher than Tg, it is undesirable since the tensile elastic modulus of the film in the stretching direction may increase. Preferably, the stretching temperature is from Tg −50° C. to Tg, more preferably from Tg −30° C. to Tg −5° C. On the other hand, when the film is stretched at the above-mentioned temperature, then the tensile elastic modulus of the film in the stretching direction may increase but the tensile elastic modulus thereof in the direction transverse to the stretching direction may tend to lower. Accordingly, for increasing the tensile elastic modulus of the film in both MD and TD by stretching, preferably, the film is stretched in the two directions, or that is, biaxially at the temperature falling within the above-mentioned range.

After the stretching step, the film may be dried. Incase where the film is dried after the stretching step, the drying temperature, the drying air flow rate and the drying time may vary depending on the solvent to be used, and the drying condition may be suitably determined depending on the type and the combination of the solvent used. In the invention, the drying temperature after the stretching step is preferably lower than the stretching temperature in the stretching step from the viewpoint of increasing the front contrast of the liquid-crystal display device into which the film is incorporated.

### (6) Winding Step:

Regarding the length thereof, the film thus produced in the manner as above is preferably wound up into a roll having a length of from 100 to 10000 m, more preferably from 500 to 7000 m, even more preferably from 1000 to 6000 m. The width of the film is preferably from 0.5 to 5.0 m, more preferably from 1.0 to 3.0 m, even more preferably from 1.0 to 2.5 m. In winding up the film, preferably, the film is knurled at least on one side thereof, and the knurling width is preferably from 3 mm to 50 mm, more preferably from 5 mm to 30 mm, and the knurling height is preferably from 0.5 to 500 μm, more preferably from 1 to 200 μm. The knurling may be in a mode of single pressing or double pressing.

Thus produced, the web is wound up to give the intended cellulose ester film.

### (Layer Configuration)

The cellulose ester film for use in the invention may be a single layer film, or may have a laminate structure of two or more layers. For example, one preferred embodiment of the film has a laminate structure of two layers of a core layer and a surface layer, as formed by co-casting.

### (Thickness of Cellulose Ester Film)

The thickness of the cellulose ester film is not specifically defined so far as the film can attain the function of a substrate film for the hard coat layer to be formed thereon. In general, the film thickness is from 30 to 80 μm.

[Hard Coat Layer]

The optical film of the invention has a hard coat layer having a thickness of from 0.1 to 6 μm, preferably from 3 to 6 μm. Having such a thin hard coat layer of which the thickness falls within the range, the optical film of the invention can have improved physical properties in point of brittleness reduction and curling prevention and can attain other advantages of weight saving and production cost cutting. In case where the substrate film is a cellulose ester film having a large elastic modulus in TD and MD and when such a thin hard coat layer of which the thickness falls within the above range is formed thereon, then the pencil hardness of the film has heretofore been lowered in any of MD or TD in which the elastic modulus of the film is smaller; however, in the invention, the pencil strength of the optical film in both MD and TD can be significantly increased and further, since the tensile elasticity of the substrate film is defined to fall within the above-mentioned range, the pencil strength of the optical film of the invention can be further increased.

In a more preferred embodiment of the optical film of the invention, the substrate film has a large elastic modulus in both TD and MD, and a curable composition is cured on the film to form the intended hard coat layer, and accordingly the optical film of the embodiment has another advantage in that the adhesiveness between the hard coat layer and the substrate film is good.

In the invention, the hard coat layer is a layer for imparting hardness and scratch resistance to the film. For example, the hard coat layer may be formed by applying a coating composition onto a substrate film (cellulose ester film) followed by curing it thereon. For imparting any other function to the film, any other functional layer maybe laminated on the hard coat layer. Filler and additive may be added to the hard coat layer to thereby make the hard coat layer itself have additional mechanical, electrical or optical physical properties or chemical properties such as water repellency or oil repellency.

Preferably, the hard coat layer is formed by curing a curable composition. Preferably, the curable composition is prepared as a liquid coating composition. One example of the coating composition contains a monomer or an oligomer for matrix formation binder, other polymer and organic solvent. Curing the coating composition applied to the substrate film forms the intended hard coat layer. The curing reaction includes crosslinking or polymerization.

### (Monomer or Oligomer for Matrix Formation Binder)

Examples of monomer or oligomer for matrix formation binder usable in the invention include ionizing radiation-curable polyfunctional monomers and polyfunctional oligomers. The polyfunctional monomers and the polyfunctional oligomers are preferably crosslinkable or polymerizable ones. The functional group in the ionizing radiation-curable polyfunctional monomers and polyfunctional oligomers is preferably one polymerizable through exposure to light, electron beam or radiation; and above all, especially preferred is a photopolymerizing functional group.

The photopolymerizing functional group includes unsaturated polymerizing functional group such as a (meth)acryloyl group, a vinyl group, a styryl group, an allyl group, etc.; a ring-opening polymerizing functional group such as those in epoxy compounds, etc. Above all, preferred is a (meth)acryloyl group.

Specific examples of the photopolymerizing polyfunctional monomer having a photopolymerizing functional group include:

(meth)acrylic diesters of alkylene glycols such as neopentyl glycol acrylate, 1,6-hexanediol (meth)acrylate, propylene glycol di(meth)acrylate, etc.;

(meth)acrylic diesters of polyoxyalkylene glycols such as triethylene glycol di(meth)acrylate, dipropylene glycol di(meth)acrylate, polyethylene glycol di(meth)acrylate, polypropylene glycol di(meth)acrylate, etc.; (meth)acrylic diesters of polyalcohols such as pentaerythritol di(meth)acrylate, etc.;

(meth)acrylic diesters of ethylene oxide or propylene oxide adducts such as 2,2-bis{4-(acryloxy.diethoxy)phenyl}propane, 2,2-bis{4-(acryloxy.polypropoxy)phenyl}propane, etc.

Further, urethane (eth)acrylates, polyester (meth)acrylates, isocyanuric acrylates and epoxy (meth)acrylates are also preferred for use herein as the photopolymerizing polyfunctional monomer.

Of the above, more preferred are esters of polyalcohols and (meth)acrylic acids, and even more preferred are polyfunctional monomers having at least three (meth)acryloyl groups in one molecule. For example, the hard coat layer perferably comprises a polymer derived from at least two kinds of polyfunctional monomers having at least three (meth)acryloyl groups in one molecule.

Concretely, there are mentioned (di)pentaerythritol tri(meth)acrylate, (di)pentaerythritol tetra(meth)acrylate, (di)pentaerythritol penta(meth)acrylate, (di)pentaerythritol hexa(meth)acrylate, tripentaerythritol triacrylate, tripentaerythritol hexaacrylate, trimethylolpropane tri(meth)acrylate, trimethylolethane tri(meth)acrylate, ditrimethylolpropane tetra(meth)acrylate, EO-modified trimethylolpropane tri(meth)acrylate, PO-modified trimethylolpropane tri(meth)acrylate, EO-modified phosphoric acid tri(meth)acrylate, 1,2,4-cyclohexane tetra(meth)acrylate, pentaglycerol triacrylate, 1,2,3-cyclohexane tetramethacrylate, polyester polyacrylate, caprolactone-modified tris(acryloxyethyl)isocyanurate, etc.

In this description, “(meth)acrylate”, “(meth)acrylic acid” and “(meth) acryloyl” each mean “acrylate or methacrylate”, acrylic acid or methacrylic acid” and “acryloyl or methacryloyl”, respectively.

Further mentioned are resins having at least 3 (meth)acryloyl groups, for example, polyester resins having a relatively low molecular weight, as well as polyether resins, acrylic resins, epoxy resins, urethane resins, alkyd resins, spiroacetal resins, polybutadiene resins, polythiol polyene resins, oligomers or prepolymers of polyfunctional compounds such as polyalcohols, etc.

As concrete compounds of polyfunctional acrylate compounds having at least 3 (meth)acryloyl groups, referred to is the description in JP-A 2007-256844, [0096], etc.

As urethane acrylates, for example, there may be mentioned urethane acrylate compounds obtained by reacting a hydroxyl group-containing compound such as alcohol, polyol and/or hydroxyl group-containing acrylate with an isocyanate followed by optionally esterifying the polyurethane compound obtained through the reaction with (meth)acrylic acid.

As specific examples of those compounds, referred to is the description in JP-A 2007-256844, [0017], etc.

Use of isocyanuric acrylates is preferred as reducing the curling of the formed film. Isocyanuric acrylates include isocyanuric diacrylates and isocyanuric triacrylates; and as examples of those compounds, referred to is the description in JP-A 2007-256844, [0018] to [0021], etc.

An epoxy compound may further be used in the hard coat layer for reducing the shrinkage of the layer through curing.

As the epoxy group-having monomers to constitute the compound, usable are monomers having at least 2 epoxy groups in one molecule. As examples of those monomers, there are mentioned epoxy monomers described in JP-A 2004-264563, 2004-264564, 2005-37737, 2005-37738, 2005-140862, 2005-140862, 2005-140863, 2002-322430, etc. Also preferred is use of compounds having both epoxy and acrylic functional groups such as glycidyl (meth)acrylate.

### (Polymer Compound)

The hard coat layer may contain a polymer compound. Adding a polymer compound to the layer is preferred, as capable of reducing the curing shrinkage of the layer and capable of facilitating the viscosity control of the coating liquid that takes an interest in the dispersion stability (coagulability) of resin particles. Other advantages of the polymer compound are that the polarity of the solidified matter in the drying step may be controlled to change the coagulation behavior of resin particles and that the drying unevenness in the drying step can be reduced.

The polymer compound is already in the form of a polymer when it is added to the coating liquid. As the polymer compound of the type, preferred for use herein are, for example, cellulose esters (e.g., cellulose triacetate, cellulose diacetate, cellulose propionate, cellulose acetate propionate, cellulose acetate butyrate, cellulose nitrate, etc.), and resins such as urethanes, polyesters, (meth)acrylates (e.g., methyl methacrylate/methyl (meth)acrylate copolymer, methyl methacrylate/ethyl (meth)acrylate copolymer, methyl methacrylate/butyl (meth)acrylate copolymer, methyl methacrylate/styrene copolymer, methyl methacrylate/(meth) acrylic acid copolymer, polymethyl methacrylate, etc.), polystyrenes etc.

### (Curable Composition)

One example of the curable composition usable for forming the hard coat layer is a curable composition containing an acrylate compound. Preferably, the curable composition contains a photoradical polymerization initiator or a thermal radical polymerization initiator along with the acrylate compound, and if desired, may further contain a filler, a coating aid and other additives. The curable composition may be cured through polymerization to be attained by exposure to ionizing radiation or to heat in the presence of a photoradical polymerization initiator or a thermal radical polymerization initiator. Ionizing radiation curing and thermal curing may be combined. As the optical and thermal polymerization initiators, usable are commercial products which are described in, for example, “Newest UV Curing Technology”, p. 159 (issued by Kazuhiro Takausu, published by Technical Information Society of Japan, 1991), and Ciba Specialty Chemicals' catalogues.

Another example of the curable composition that can be used in forming the hard coat layer is a curable composition containing an epoxy compound. Preferably, the curable composition of the type contains an optical acid generator capable of generating a cation by the action of light applied thereto, along with the epoxy compound therein, and may optionally contain a filler, a coating aid and other additives. The curable composition may be cured through polymerization to be attained by exposure to light in the presence of an optical acid generator. Examples of the optical acid generator include ionic compounds such as triarylsulfonium salts, diaryliodonium salts, etc.; and nonionic compounds such as sulfonic acid nitrobenzyl ester, etc. Various types of known optical acid generators such as the compounds described “Imaging Organic Material” (edited by Organic Electronics Material Society of Japan, published by Bunshin Publishing, 1997), etc.

An acrylate compound and an epoxy compound may be combined for use herein. In such a case, preferably, a photoradical polymerization initiator or a thermal polymerization initiator is combined with an optical cationic polymerization initiator.

Preferably, the curable composition is prepared as a coating liquid. The coating liquid may be prepared by dissolving and/or dispersing the above-mentioned ingredients in an organic solvent.

### (Property of Hard Coat Layer)

Preferably, the hard coat layer is excellent in abrasion resistance. Concretely, when the layer is tested in a pencil hardness test that is an index of abrasion resistance, the layer attains at least 3H in both MD and TD, more preferably at least 4H.

### [Use of Optical Film]

The optical film of the invention is useful in various applications of a polarizer protective film, a surface protective film to be disposed on the display side of display panel, etc. For attaining the function suitable for those applications, the optical film may additionally have any other layer along with the cellulose ester film and the hard coat layer. For example, the optical film may have an antiglare layer, a clear hard coat layer, as well as an antireflection layer, an antistatic layer, an antifouling layer, etc.

### 2. Polarizer:

The invention also relates to a polarizer having the optical film of the invention and a polarizing element.

The polarizer of the invention can be produced in ordinary methods. For example, a polarizing element maybe stuck to the back side of the cellulose ester film (on which the hard coat layer is not formed) of the optical film of the invention to produce the polarizer. Preferably, the surface of the cellulose ester to which the polarizing element is stuck is alkali-saponified. In sticking the two, usable is an aqueous solution of a completely saponified polyvinyl alcohol.

As the polarizing element, usable here is any known one. For example, a film of a hydrophilic polymer, such as polyvinyl alcohol or an ethylene-modified polyvinyl alcohol having an ethylene unit content of from 1 to 4 mol %, a degree of polymerization of from 2000 to 4000 and a degree of saponification of from 99.0 to 99.99 mol % is processed with a dichroic dye such as iodine and stretched, or a plastic film of polyvinyl chloride or the like is processed and oriented to produce the polarizing element for use herein.

Preferably, the thickness of the polarizing element is from 5 to 30 μm. A polarizer protective film is stuck to the thus-produced polarizing element.

Preferably, a protective film is stuck also to the side of the polarizing element to which the optical film of the invention is not stuck. The protective film is not specifically defined in point of the optical properties and the material thereof. An optically isotropic film may be used, or an optically anisotropic retardation film may also be used. In an embodiment where the polarizer of the invention is used in a liquid-crystal display device, in general, the hard coat layer-having optical film of the invention is positioned on the outside of the panel surface. Accordingly, the other protective film is positioned between the polarizing element and the liquid-crystal cell, and therefore as the other protective film, usable is a retardation film that contributes toward optical compensation of the birefringence of the liquid-crystal cell. As the other protective film, herein usable are cellulose ester films, cyclic polyolefin films, polycarbonate films, etc.

Preferably, the polarizer protective film to be applied to the panel side of a display device has, in addition to the antiglare layer or the clear hard coat layer, an antireflection layer, an antistatic layer and an antifouling layer.

In case where a polarizer is produced and when the cellulose ester film, which the optical film of the invention has, has an in-lane slow axis, it is desirable that the optical film is stuck to the polarizing element in such a manner that the in-plane slow axis of the cellulose ester film is parallel to or perpendicular to the transmission axis of the polarizing element.

### 3. Image Display Device:

The invention also relates to an image display device having the optical film of the invention. The function of the optical film of the invention in the image display device is not specifically defined. In one example, the optical film of the invention is the surface protective film arranged on the display side of the panel of the display device.

The image display device is not also specifically defined. The display device may be a liquid-crystal display device having a liquid-crystal cell, or an organic EL image display device having an organic EL layer, or may also be a plasma image display device. The optical film of the invention contains a cellulose ester film, and therefore can be stuck to a polarizing element with ease and in a simplified manner, and consequently, the optical film of the invention is suitable for use in a liquid-crystal display device that comprises a polarizer as an indispensable member therein.

### [Liquid-Crystal Display Device]

The liquid-crystal display device of the invention is characterized by having the polarizer of the invention. Preferably, the polarizer of the invention is arranged on the display side of the panel of the device, and is more preferably so arranged that the optical film of the invention is on the outer side of the display panel of the device. For the other configuration of the device, any one employable in known liquid-crystal display devices can be employed here. The display mode of the device is not also specifically defined. The optical film of the invention is applicable to various display modes of liquid-crystal display devices, including TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned), HAN (hybrid aligned nematic) modes, etc.

### EXAMPLES

The characteristic features of the invention are described more concretely with reference to the following Examples and Comparative Examples. In the following Examples, the material used, its amount and ratio, the details of the treatment and the treatment process may be suitably modified or changed not overstepping the spirit and the scope of the invention. Accordingly, the invention should not be limitatively interpreted by the Examples mentioned below.

### Examples 1 to 12 and Comparative Examples 1 to 6

### 1. Production of Optical Film

### (1) Production of Cellulose Ester Film:

The following ingredients were put into a mixing tank and dissolved by stirring to prepare a solution.

TABLE 4
Cellulose Acylate Solution

| | | amount added |
|---|---|---|
| Ingredients | type | (parts by mass) |
| Cellulose | cellulose acetate having a degree | 100 |
| Acylate | of acetyl substitution of 2.86 | |
| Additive 1 | shown in Table 6 | shown in Table 6 |
| Additive 2 | shown in Table 6 | shown in Table 6 |
| Methylene | — | 365.8 |
| Chloride | | |
| Methanol | — | 92.6 |
| Butanol | — | 4.6 |

The dope was formed into a film according to a solution casting method, and then, as the case may be, this was TD stretched at the draw ratio shown in Table 6, thereby producing a cellulose ester film. After stretched, the thickness of the film was 40 μm. While MD-conveyed, the film was MD-stretched at the draw ratio falling within a range of from 0 to 10%. Concretely, in Examples 1, 3, 4 and 12, the draw ratio was 3%; in Examples 2 and 5 to 7, the draw ratio was 5%; in Examples 8 to 10, the draw ratio was 7%; in Example 11, the draw ratio was 10%; and in Comparative Example 3, the draw ratio was 7%. The temperature in stretching was within a range of from (Tg −30) to (Tg −5)° C. where Tg indicates the glass transition point of the film.

The formed film was analyzed for the MD and TD tensile elastic modulus thereof. The found data are shown in Table 6.

### (2) Formation of Hard Coat Layer:

A curing composition for hard coat layer mentioned below was prepared for the coating liquid for hard coat layer.

TABLE 5

| | | | | Total Amount of | | Amount of | | | |
|---|---|---|---|---|---|---|---|---|---|
| | | | Monomer 1/ | Monomers 1 and 2 | UV | UV initiator | Solvent | Solvent | Solvent 1/ |
| | Monomer 1 | Monomer 2 | Monomer 2 | [part by mass] | Initiator | [part by mass] | 1 | 2 | Solvent 2 |
| Hard Coat | pentaerythritol | pentaerythritol | 3/2 | 53.5 | UV | 1.5 | ethyl | — | — |
| Layer 1 | triacrylate | tetraacrylate | | | initiator 1 | | acetate | | |

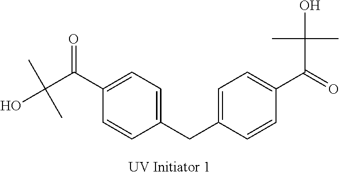

The hard coat layer forming liquid 1 mentioned above was applied on one surface of the cellulose ester film, then dried at 100° C. for 60 seconds, and irradiated with UV under the condition of 0.1% nitrogen at 1.5 kW in a dose of 300 mJ, whereby the liquid was cured to form a hard coat layer having a thickness shown in Table 6. The thickness of the layer was controlled by controlling the coating amount according to a die coating method using a slot die.

In the manner as above, optical films of Examples and Comparative Examples were produced, each having the hard coat layer formed on the cellulose ester film.

### 2. Evaluation of Optical Film

### (1) Pencil Hardness of Hard Coat Layer:

The optical film was conditioned at 25° C. and at a relative humidity of 60% for 2 hours, and then tested according to the pencil hardness test method of JIS-K5400 using a test pencil defined in JIS-S6006. The pencil hardness of the hard coat layer of the film both in MD and TD was thus measured, and the film was evaluated. Concretely, using a weight of 500 g, the surface of the hard coat layer was scratched repeatedly for a total of five times with a pencil having a different hardness, and the hardness of the tested pencil with which the sample had been given one scratch was determined. The scratch defined in JIS-K5400 is a breakage of the coating film or the scratch of the coating film and does not include a dent of the coating film. However, in this test, the scratch included a dent of the coating layer. For practical use, the value of at least 3H is preferred; and samples having a higher value is more favorable as having a higher hardness. The results are shown in Table 6.

### (2) Adhesiveness:

The optical film was tested in a cross-cut peeling test according to JIS-K5600. Concretely, after the substrate film was coated with the hard coat layer coating liquid and UV-cured, and, before the hard coat layer was cross-cut, the film was irradiated with Xe for 50 hours. After Xe irradiation, the surface of the sample was cross-cut in 11 lines in length and width directions each at intervals of 1 mm, thereby forming 100 cross-cuts of 1 mm square. A cellophane tape and a Mylar tape were stuck to the thus cross-cut surface, and rapidly peeled, whereupon the surface was visually observed and the peeled cross-cuts were counted.

For Xe irradiation, sued was Suga Test Instruments' Super Xenon Weather Meter SX75. The adhesiveness between the cellulose ester film and the hard coat layer was evaluated according to the following criteria.

Excellent, A: 0 to 10 cross-cuts peeled.

Good or Average, B: 11 to 50 cross-cuts peeled.

Not good, C: 51 or more cross-cuts peeled.

The results are shown in Table 6.

TABLE 6

| | Additive 1 | | Additive 2 | | Tensile Elastic | | Thickness of | Pencil | | |
|---|---|---|---|---|---|---|---|---|---|---|
| | type | Mean Ester | type | TD Draw | Modulus GPa | | Hard Coat | Hardness | | |
| | (% by mass) | Substitution Ratio % | (% by mass) | Ratio % | MD | TD | Layer μm | MD | TD | Adhesiveness |
| Example 1 | sugar ester 1 | 71 | — | — | 4.0 | 4.0 | 5 | 3H | 3H | A |
| | (12) | | | | | | | | | |
| Example 2 | sugar ester 1 | 71 | — | — | 4.4 | 4.4 | 5 | 4H | 4H | A |
| | (12) | | | | | | | | | |
| Example 3 | sugar ester 1 | 71 | sugar ester 2 | — | 4.0 | 4.0 | 5 | 3H | 3H | A |
| | (9) | | (3) | | | | | | | |
| Example 4 | sugar ester 1 | 71 | sugar ester 2 | — | 4.2 | 4.2 | 5 | 3H | 3H | A |
| | (9) | | (3) | | | | | | | |
| Example 5 | sugar ester 1 | 71 | sugar ester 2 | — | 4.3 | 4.3 | 6 | 4H | 4H | A |
| | (9) | | (3) | | | | | | | |
| Example 6 | sugar ester 1 | 71 | sugar ester 2 | — | 4.4 | 4.4 | 5 | 4H | 4H | A |
| | (9) | | (3) | | | | | | | |
| Example 7 | sugar ester 1 | 71 | sugar ester 2 | 30 | 4.4 | 5.0 | 5 | 4H | 4H | A |
| | (9) | | (3) | | | | | | | |
| Example 8 | sugar ester 1 | 71 | sugar ester 2 | — | 5.0 | 4.4 | 5 | 4H | 4H | A |
| | (9) | | (3) | | | | | | | |
| Example 9 | sugar ester 1 | 71 | sugar ester 2 | 30 | 5.0 | 5.0 | 0.2 | 3H | 3H | A |
| | (9) | | (3) | | | | | | | |
| Example 10 | sugar ester 1 | 71 | sugar ester 2 | 30 | 5.0 | 5.0 | 5 | 4H | 4H | A |
| | (9) | | (3) | | | | | | | |
| Example 11 | sugar ester 1 | 71 | sugar ester 2 | 40 | 5.5 | 5.5 | 5 | 4H | 4H | A |
| | (9) | | (3) | | | | | | | |
| Example 12 | sugar ester 1-SB | 94 | — | — | 4.0 | 4.0 | 5 | 3H | 3H | A |
| | (12) | | | | | | | | | |
| Comparative | phosphate | — | — | — | 3.7 | 3.7 | 10 | 3H | 3H | B |
| Example 1 | (12) | | | | | | | | | |
| Comparative | — | — | — | — | 3.7 | 3.7 | 5 | 2H | 2H | A |
| Example 2 | | | | | | | | | | |
| Comparative | phosphate | — | — | — | 4.6 | 3.5 | 5 | 3H | 2H | B |
| Example 3 | (12) | | | | | | | | | |
| Comparative | phosphate | — | — | 30 | 3.1 | 4.4 | 5 | 2H | 3H | B |
| Example 4 | (12) | | | | | | | | | |
| Comparative | phosphate | — | — | 30 | 2.5 | 4.4 | 5 | less | 3H | B |
| Example 5 | (11) | | | | | | | than 2H | | |
| Comparative | trimellitate | — | — | — | 3.5 | 3.5 | 5 | 2H | 2H | C |
| Example 6 | (11) | | | | | | | | | |

In Table 6, phosphate is a 7/3 (by mol) mixture of triphenyl phosphate (TPP) and biphenyldiphenyl phosphate (BDP); and trimellitate is tributyl trimellitate.

In Table 6, sugar ester 1, sugar ester 1-SB and sugar ester 2 each are a compound or mixture having the structure mentioned below. The mean ester substitution ratio of sucrose benzoates, sugar ester 1 and sugar ester 1-SB was determined according to the method mentioned below.

The esters were analyzed through HPLC under the condition mentioned below. The peak indicating the retention time of around 31.5 minutes is an 8-substitution derivative group; the peak indicating the retention time of around from 27 to 29 minutes is a 7-substitution derivative group; the peak indicating the retention time of around from 22 to 25 minutes is a 6-substitution derivative group; the peak indicating the retention time of around from 15 to 20 minutes is a 5-substitution derivative group; the peak indicating the retention time of around from 8.5 to 13 minutes is a 4-substitution derivative group; and the peak indicating the retention time of around from 3 to 6 minutes is a 3-substitution derivative group. The mean substitution ratio of each group to the total area of all the groups was computed.

### <<HPLC Condition>>

### Column: TSK-gel ODS-100Z (Tosoh), 4.6*150 mm, Lot Number (P0014).

Eluent A: H₂O=100, Eluent B: AR=100. A and B both contained 0.1% of AcOH and 0.1% of NEt₃.
Flow Rate: 1 ml/min.

### Column Temperature: 40° C.

### Wavelength: 254 nm.

### Sensitivity: AUX2.

### Injected Sample Amount: 10 μl.

Rinsing Liquid: THF/H₂O=9/1 (by volume).
Sample Concentration: 5 mg/10 ml (THF).

The mean ester substitution ratio of the sugar ester 2 could be determined in the same manner as above. However, the sugar ester 2 was a single compound having an ester substitution ratio of nearly 100%.

All the sucrose benzoates to be used in Examples were dried under reduced pressure (10 mmHg or less), in which the content of the reaction solvent, toluene was less than 100 ppm.

### Sugar Ester 1: Having a Mean Ester Substitution Ratio of 71%.

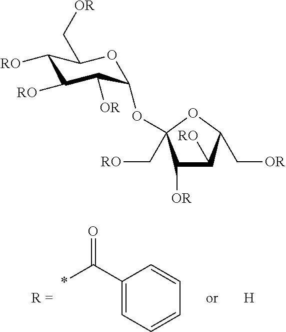

### Sugar Ester 1-Sb: Monopet Sb (by Daiichi Kogyo, Having a Mean Ester Substitution Ratio of 94%).

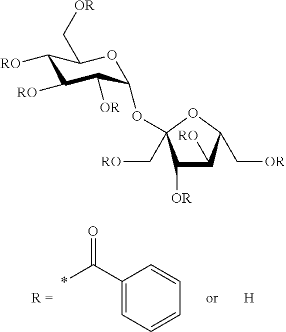

### Sugar Ester 2: Having a Mean Ester Substitution Ratio of 1000 (Single Compound).

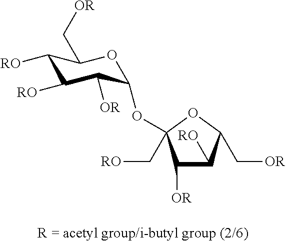

From the results in Table 6 above, it is known that the optical films of Examples of the invention all had a pencil hardness of 3H or more both in MD and TD and are excellent in abrasion resistance and, in addition, the films are all excellent in adhesiveness between the hard coat layer and the substrate film.

On the other hand, it is known that, in Comparative Examples 2 and 6, the tensile elastic modulus of the substrate film, cellulose ester film was small, and therefore even though the thickness of the hard coat layer was on the same level as that in Examples, the abrasion resistance of the optical films of these Comparative Examples was significantly poor.

In Comparative Examples 3 to 5, the tensile elastic modulus in any one direction of TD or MD of the substrate film, cellulose ester film was high, and therefore the abrasion resistance of the optical film was poor in any one direction and was unsatisfactory.

In Comparative Example 1, the hard coat layer was thick and therefore the abrasion resistance of the optical film was good; however, this does not satisfy the requirement of reducing the thickness of the hard coat layer to at most 6 μm, as required recently in the art, and therefore the optical film was not practicable.

### Examples 101 to 112, Comparative Examples 101 to 106

Optical films of Examples and Comparative Examples were produced in the same manner as in Examples 1 to 12 and Comparative Examples 1 to 6, except that the thickness of the cellulose ester film was changed from 40 μm to 25 μm, and evaluated also in the same manner as above. The results donated the same tendency as in Examples 1 to 12 and Comparative Examples 1 to 6.

### Examples 201 to 212, Comparative Examples 201 to 206

### Production of Liquid-Crystal Display Device

A polarizer was produced, using the film of Examples 1 to 12 and Comparative Examples 1 to 6 as the protective film on the front-side surface thereof. Incorporated in an IPS liquid-crystal panel and tested, the polarizer was confirmed to have no problem in practical use.

The produced liquid-crystal display device was confirmed to be excellent in durability in high-temperature high-humidity environments.

### Example 301, and Comparative Examples 301 and 302

A curing composition for hard coat layer 2 mentioned below was prepared for the coating liquid for hard coat layer.

TABLE 7

| | | | | Total Amount of | | Amount of | | | |
|---|---|---|---|---|---|---|---|---|---|
| | | | Monomer 1/ | Monomers 1 and 2 | UV | UV initiator | Solvent | Solvent | Solvent 1/ |
| | Monomer 1 | Monomer 2 | Monomer 2 | [part by mass] | Initiator | [part by mass] | 1 | 2 | Solvent 2 |
| Hard Coat | pentaerythritol | pentaerythritol | 3/2 | 29.25 | Irgacure | 0.75 | MIBK | MEK | 49/21 |
| Layer 2 | triacrylate | tetraacrylate | | | 907 | | | | |

The compounds used in the hard coat layer coating liquid are shown below.

Irgacure 907: UV polymerization initiator (by Ciba Japan).

MIBK: methyl isobutyl ketone.

MEK: methyl ethyl ketone.

Optical films of Example 301 and Comparative Examples 301 and 302 were produced in the same manner as in Example 6, except that the hard coat layer coating liquid 2 obtained in the above was used to have a thickness shown in Table 8 below.

Thus produced, the optical films of Example and Comparative Examples was tested for the pencil hardness in TD of the hard coat layer thereof, in the same manner as in Example 6. The results are shown in Table 8.

### (Evaluation of Curling)

The optical film of Examples and Comparative Examples was cut into a piece of 35 mm×125 mm, put on a flat plate at a temperature of 25° C. and at a relative humidity of 60% for 2 hours, and the swelling height of the four edges of the sample was measured. Based on the mean value of the found data, the sample was evaluated according to the following 3-grade evaluation.

The results are shown in Table 8.

A: less than 10 mm.

B: from 10 mm to less than 15 mm.

C: 15 mm or more.

TABLE 8

| | | | Thick- | | |
|---|---|---|---|---|---|
| | | | ness | | |
| | | | of Hard | Pencil | |
| | | Hard Coat Layer | Coat | Hard- | Curl- |
| | Base | Coating Liquid | Layer | ness | ing |
| Example 301 | base used in | hard coat layer 2 | 6 μm | 3H | A |
| | Example 6 | | | | |
| Comparative | base used in | hard coat layer 2 | 7 μm | 3H | B |
| Example 301 | Example 6 | | | | |
| Comparative | base used in | hard coat layer 2 | 10 μm | 3H | C |
| Example 302 | Example 6 | | | | |

From the above Table 8, it is known that the optical film of Example 301 with a hard coat layer having a thickness of 6 μm curls little. On the other hand, the optical films of Comparative Examples 301 and 302 each with a hard coat layer having a thickness of more than 6 μm curl relatively seriously.

### Example 401, Formation of Cellulose Ester Film 101 on Drum

### Preparation of Cellulose Ester Solution 1-A

The following ingredients were put into a mixing tank and dissolved by stirring under heat, thereby preparing a cellulose ester solution (1-A). The degree of acetylation of the ester was determined according to ASTM D-817-91. The viscosity-average degree of polymerization of the ester was determined according to the Uda et al's limiting viscosity method (Kazuo Uda & Hideo Saito, “Journal of Society of Fiber Science and Technology, Japan”, Vol. 18, No. 1, pp. 105-120, 1962).

Composition of Cellulose Ester Solution 1-A

| | |
|---|---|
| Cellulose Ester (degree of acetyl substitution, | 100.0 parts by mass |
| 2.86; viscosity-average degree of polymerization, | |
| 310) | |
| Sugar Ester 1 | 5.5 parts by mass |
| Sugar Ester 2 | 1.5 parts by mass |
| Methylene Chloride | 384 parts by mass |
| Methanol | 69 parts by mass |
| Butanol | 9 parts by mass |

### (Preparation of Mat Agent Dispersion 1-B)

The following ingredients were put into a disperser and dispersed by stirring, thereby preparing a mat agent dispersion (1-B).

Composition of Mat Agent Dispersion (1-B)

| | |
|---|---|
| Silica Particles having a mean particle size of 16 nm | 10.0 parts by mass |
| (AEROSIL R972, by Nippon Aerosil) | |
| Methylene Chloride | 72.8 parts by mass |
| Methanol | 3.9 parts by mass |
| Butanol | 0.5 parts by mass |
| Cellulose Ester Solution (1-A) | 10.3 parts by mass |

### (Preparation of UV Absorbent Solution 1-C)

The following ingredients were put into a mixing tank and dissolved by stirring under heat, thereby preparing a UV absorbent solution (1-C).

Composition of UV Absorbent Solution (1-C)

| | |
|---|---|
| UV Absorbent (UV-1 mentioned below) | 10.0 parts by mass |
| UV Absorbent (UV-2 mentioned below) | 10.0 parts by mass |
| Methylene Chloride | 55.7 parts by mass |
| Methanol | 10 parts by mass |
| Butanol | 1.3 parts by mass |
| Cellulose Ester Solution (1-A) | 12.9 parts by mass |

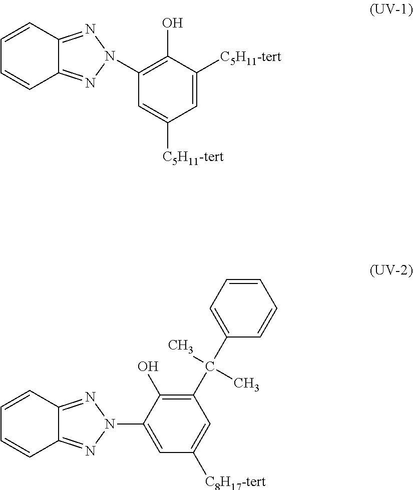

### (Production of Cellulose Ester Film 101)

The mat agent dispersant (1-B) was added to the cellulose ester solution (1-A) in such a manner that the amount of the sugar ester 1 and the amount of the sugar ester 2 in the resulting mixture could be as in Table 9 relative to 100 parts by mass of the cellulose ester therein. The UV absorbent solution (1-C) was added to the resulting solution in such a manner that the amount of the UV absorbent (UV-1) and that of the UV absorbent (UV-2) therein could be 1.0 part by mass each, and well stirred under heat to dissolve the ingredients, thereby preparing a dope. The obtained dope was heated at 30° C., and cast onto a mirror-finished stainless support drum having a diameter of 3 m, via a casting Giesser. The surface temperature of the support was set at −5° C., and the coating width was 1470 mm. The spatial temperature in the entire casting zone was set at 15° C. At 50 cm before the end point of the casting zone, the cast and rotated cellulose ester film was peeled from the drum, and both sides thereof were clipped with a pin tenter. Just after peeled, the residual solvent amount in the cellulose ester web was 70% and the surface temperature of the cellulose ester web was 5° C.

The cellulose ester web held with the pin tenter was conveyed into a drying zone. First, the web was dried with drying air at 45° C. Next, the web was dried at 110° C. for 5 minutes and then at 140° C. for 10 minutes.

The thickness of the thus-produced cellulose ester film was 40 μm.

The hard coating liquid 1 was applied onto one surface of the cellulose ester film 101, then dried at 100° C. for 60 seconds, and irradiated with UV under the condition of 0.10 nitrogen at 1.5 kW in a dose of 300 mJ, whereby the liquid was cured to form a hard coat layer having a thickness shown in Table 9. The thickness of the layer was controlled by controlling the coating amount according to a die coating method using a slot die.

In the manner as above, an optical film of Example 401 was produced, having a hard coat layer formed on a cellulose ester film.

### Example 402: Formation of Cellulose Ester Film 102 on Band

### Preparation of Cellulose Ester Solution 2-A

The following ingredients were put into a mixing tank and dissolved by stirring, thereby preparing a cellulose ester solution (2-A).

Composition of Cellulose Ester Solution 2-A

| | |
|---|---|
| Cellulose Ester (degree of acetyl substitution, 2.86; | 100.0 parts by mass |
| viscosity-average degree of polymerization, 310) | |
| Sugar Ester 1 | 6 parts by mass |
| Sugar Ester 2 | 3 parts by mass |
| Methylene Chloride | 402.0 parts by mass |
| Methanol | 60.0 parts by mass |

### Preparation of Mat Agent Dispersion 2-B

The following ingredients were put into a disperser and dispersed by stirring, thereby preparing a mat agent dispersion (2-B).

Composition of Mat Agent Dispersion (2-B)

| | |
|---|---|
| Silica Particles having a mean particle size of 20 nm | 2.0 parts by mass |
| (AEROSIL R972, by Nippon Aerosil) | |
| Methylene Chloride | 75.0 parts by mass |
| Methanol | 12.7 parts by mass |
| Cellulose Ester Solution (2-A) | 10.3 parts by mass |

### (Preparation of UV Absorbent Solution 2-C)

The following ingredients were put into a mixing tank and dissolved by stirring under heat, thereby preparing a UV absorbent solution (2-C).

Composition of UV Absorbent Solution (2-C)

| | |
|---|---|
| UV Absorbent (UV-1 mentioned above) | 10.0 parts by mass |
| UV Absorbent (UV-2 mentioned above) | 10.0 parts by mass |
| Methylene Chloride | 67.2 parts by mass |
| Methanol | 10.0 parts by mass |
| Cellulose Ester Solution (2-A) | 12.8 parts by mass |

1.3 parts by mass of the above mat agent dispersion (2-B) and 3.1 parts by mass of the UV absorbent solution (2-C) were, after separately filtered, mixed in an in-line mixer, and 95.6 parts by mass of the cellulose ester solution (2-A) was added thereto and further mixed in the in-line mixer. The mixed solution was cast, using a band caster, and dried at 100° C. to have a residual solvent amount of 40%, and the film was peeled. The peeled film was stretched at a draw ratio of 30% in the direction transverse to the machine direction thereof, using a tenter stretcher at an atmospheric temperature of 150° C. The stretched film was further dried at 140° C. for 20 minutes. The thickness of the thus-obtained cellulose ester film 102 was 40 m.

The hard coating liquid 1 was applied onto one surface of the cellulose ester film 102, then dried at 100° C. for 60 seconds, and irradiated with UV under the condition of 0.10 nitrogen at 1.5 kW in a dose of 300 mJ, whereby the liquid was cured to form a hard coat layer having a thickness shown in Table 9. The thickness of the layer was controlled by controlling the coating amount according to a die coating method using a slot die.

In the manner as above, an optical film of Example 402 was produced, having a hard coat layer formed on a cellulose ester film.

### (Evaluation)

The obtained optical films of Examples were tested for the pencil hardness of the hard coat layer and for the adhesiveness between the cellulose ester film and the hard cot layer, in the same manner as in Example 1. The results are shown in Table 9 below.

TABLE 9

| | Additive 1 | | Additive 2 | Tensile Elastic | | Thickness of | Pencil | | |
|---|---|---|---|---|---|---|---|---|---|
| | type | Mean Ester | type | Modulus [GPa] | | Hard Coat | Hardness | | Adhesiveness |
| | (% by mass) | Substitution Ratio % | (% by mass) | MD | TD | Layer [μm] | MD | TD | A |
| Example 401 | sugar ester 1 | 71 | sugar ester 2 | 4.0 | 4.0 | 5 | 3H | 3H | A |
| | (5.5) | | (1.5) | | | | | | |
| Example 402 | sugar ester 1 | 71 | sugar ester 2 | 4.0 | 4.0 | 5 | 3H | 3H | A |
| | (6) | | (3) | | | | | | |

From Table 9 above, it is known that the optical film of Example 401 produced by the use of the cellulose ester film formed on a drum and the optical film of Example 402 produced by the use of the cellulose ester film formed on a band both had a pencil hardness of 3H both in MD and TD and are excellent in abrasion resistance and, in addition, the films are both excellent in adhesiveness between the hard coat layer and the substrate film.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 2011-080595 filed on Mar. 31, 2011 and Japanese Patent Application No. 2011-204677 filed on Sep. 20, 2011, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. An optical film comprising a cellulose ester film and, as formed on at least one surface thereof, a hard coat layer having a thickness of from 0.1 to 6 μm, wherein the tensile elastic modulus of the cellulose ester film both in the machine direction (MD) thereof and in the direction transverse to the machine direction (TD) thereof is at least 4.0 GPa.

2. The optical film according to claim 1, wherein the tensile elastic modulus of the cellulose ester film both in the machine direction (MD) thereof and in the direction transverse to the machine direction (TD) thereof is from 4.0 GPa to 5.5 GPa.

3. The optical film according to claim 1, wherein the ratio of the TD tensile elastic modulus to the MD tensile elastic modulus of the cellulose ester film is less than 1.4.

4. The optical film according to claim 3, wherein the ratio of the TD tensile elastic modulus to the MD tensile elastic modulus of the cellulose ester film is from 0.9 to 1.2.

5. The optical film according to claim 1, wherein the cellulose ester film comprises at least one sugar ester.

6. The optical film according to claim 5, wherein the cellulose ester film comprises the sugar ester in an amount of from 2% by mass to less than 25% by mass relative to the cellulose ester.

7. The optical film according to claim 5, wherein the sugar ester is a mixture of multiple sugar ester compounds that are the same in point of the type of the ester substituent therein but differ in point of the degree of ester substitution therein.

8. The optical film according to claim 7, wherein the mean ester substitution ratio of the multiple sugar ester compounds differing in point of the degree of ester substitution therein is from 62 to 94%.

9. The optical film according to claim 5, wherein the sugar ester is a mixture of a sugar ester substituted with an ester group having an aromatic ring-comprising group and a sugar ester substituted with an ester group having an aliphatic acyl group.

10. The optical film according to claim 9, wherein the mean ester substitution ratio of the sugar esters substituted with an ester group having an aromatic ring-containing group is from 62% to 94%.

11. The optical film according to claim 9, wherein the blend ratio of the sugar ester substituted with an ester group having an aromatic ring-containing group to the sugar ester substituted with an ester group having an aliphatic acyl group is at least ⅓.

12. The optical film according to claim 1, wherein the cellulose ester film is a stretched film.

13. The optical film according to claim 1, wherein the cellulose ester is a cellulose acetate.

14. The optical film according to claim 1, wherein the cellulose ester has a degree of acetyl substitution of from 2.70 to 2.95.

15. The optical film according to claim 1, wherein the cellulose ester has a degree of acetyl substitution of from 2.82 to 2.87.

16. The optical film according to claim 1, wherein the hard coat layer is a polyfunctional (meth)acrylate-base hard coat layer.

17. The optical film according to claim 16, wherein the hard coat layer comprises a polymer derived from at least two kinds of polyfunctional monomers having at least three (meth)acryloyl groups in one molecule.

18. An image display device having an optical film on the display surface of the panel thereof, wherein the optical film comprising a cellulose ester film and, as formed on at least one surface thereof, a hard coat layer having a thickness of from 0.1 to 6 μm, wherein the tensile elastic modulus of the cellulose ester film both in the machine direction (MD) thereof and in the direction transverse to the machine direction (TD) thereof is at least 4.0 GPa.

19. A polarizer having a polarizing element and an optical film, wherein the optical film comprising a cellulose ester film and, as formed on at least one surface thereof, a hard coat layer having a thickness of from 0.1 to 6 μm, wherein the tensile elastic modulus of the cellulose ester film both in the machine direction (MD) thereof and in the direction transverse to the machine direction (TD) thereof is at least 4.0 GPa.

20. A liquid-crystal display device at least having a polarizer having a polarizing element and an optical film, wherein the optical film comprising a cellulose ester film and, as formed on at least one surface thereof, a hard coat layer having a thickness of from 0.1 to 6 μm, wherein the tensile elastic modulus of the cellulose ester film both in the machine direction (MD) thereof and in the direction transverse to the machine direction (TD) thereof is at least 4.0 GPa.
